(19) United States
(12) Patent Application Publication
(10) Pub. No.: US 2014/0195450 A1
(43) Pub. Date: Jul. 10, 2014

(54) Method and System for Course Evaluation

(71) Applicant: CourseMaven, Leesburg, VA (US)

(72) Inventor: Janet Marie Van Pelt, Leesburg, VA (US)

(73) Assignee: CourseMaven, Leesburg, VA (US)

(21) Appl. No.: 14/147,771

(22) Filed: Jan. 6, 2014

Related U.S. Application Data
(60) Provisional application No. 61/750,467, filed on Jan. 9, 2013.

(51) Int. Cl. G06Q 50/20

(52) U.S. Cl. CPC G06Q 50/2053
USPC 705/327

(57) ABSTRACT

The present disclosure provides a method for receiving enrollment for a course. A method may include receiving course search criteria and providing a list of courses matching the course search criteria. Course details may be provided for each of the courses in the list, and the course details may include identification of an institution offering the course. A request to enroll for a course may be received and enrollment information may be provided to the institution. An indication may be received from the institution that enrollment for the course is complete. Additionally, a method for providing course options to a user is provided. A user selection of a first course offered at a first institution may be received. An equivalent course offered at a second institution that is accepted as an equivalent course at the first institution may be identified and the equivalent course may be presented to the user.

### PRIORITY

This application claims the benefit of U.S. Provisional Application No. 61/750,467, filed Jan. 9, 2013.

### BACKGROUND

Under a traditional higher education model, a student chooses a college (2 or 4 year) and a degree program and completes courses at that college to earn the degree. Occasionally students transfer to another institution, in which case the courses taken at the original institution are translated (articulated) to equivalent courses at the target institution, but otherwise the process remains largely the same.

Today, however, this traditional educational model is dramatically changing. Students increasingly want the ability to take courses toward a desired educational credential from multiple institutions, perhaps to achieve their goals at a lower cost or in less time, perhaps because they have difficulty enrolling in all their required courses from a single institution due to schedule constraints or oversubscribed courses. Further, the definition of a post-secondary course is being greatly expanded. Many mainstream colleges and universities now offer online courses for which they award students a certificate of completion. Such a certificate frequently does not provide college credit from the institution that offered the course, but other institutions may accept it as evidence of educational achievement and award credit for the course. Employers increasingly understand that job candidates with some combination of college credit, non-credit courses, and real world experience may better satisfy job requirements than a candidate with an earned degree and so are willing to evaluate educational background at the course level rather than the degree level. And social policy considerations and legislative actions in many states create an imperative for colleges to look at individual credit and non-credit courses regardless of where earned in determining remaining degree requirements.

### BRIEF SUMMARY

According to an implementation of the disclosed subject matter, a method for receiving enrollment for a course may include receiving course search criteria and providing a list of courses matching the course search criteria. Course details may be provided for each of the courses in the list of courses and the course details may include identification of an institution offering the course. A request to enroll for the course may be received and enrollment information may be provided to the institution. An indication may be received from the institution that enrollment for the course is complete.

In an implementation, filtering criteria for filtering the list of courses may be received and the list of courses may be filtered based on the filtering criteria.

According to an implementation, the filtering criteria may be at least one of physical location of a course, format of a course, date/time of a course, course equivalencies, credential requirements at a specific institution satisfied by a course, cost of a course, and/or a course prerequisite.

In an implementation, the list of courses may include courses from multiple educational institutions.

According to an implementation, enrollment information may be requested from a user based on an enrollment requirement of the institution offering the course. In an implementation, enrollment information may be requested from a user who has requested to enroll in the course.

In an implementation, enrollment information may be user name, user address, user payment information, user billing information, user personal identification information, user eligibility information, user's previous credit hours earned, user GPA, and/or other information necessary for enrollment.

In an implementation, enrollment information may be requested from a third-party based on an enrollment requirement of the institution offering the course.

According to an implementation of the disclosed subject matter, a method for providing course options to a user may include receiving a user selection of a first course offered at a first institution and identifying an equivalent course offered at a second institution that is accepted as an equivalent course at the first institution. As a result, the equivalent course may be presented to the user.

In an implementation, identifying an equivalent course may be based on at least one attribute of an entity such as the user, first institution, second institution, course offered at the first institution, and/or the equivalent course offered at the second institution.

In an implementation, a request to enroll for the equivalent course offered at the second institution may be received and enrollment information may be provided to the second institution. An indication from the second institution that enrollment for the equivalent course is complete may be received.

In an implementation, prior to receiving the user selection of a course offered at the first institution, the user may be provided with a list of courses matching a course search criteria and the list may include the first course.

According to an implementation, filtering criteria for filtering the list of courses may be received and the list of courses may be filtered based on the filtering criteria.

In an implementation, enrollment information may be requested from a user based on an enrollment requirement of the second institution.

According to an implementation of the disclosed subject matter, a method for generating a map of course equivalencies may include receiving a list of courses offered by a first institution and receiving course information for each of the courses in the list. Equivalent courses may be identified for each of the courses in the list offered by a second institution. A map of course equivalencies may be generated based on the equivalent courses identified.

In an implementation, equivalent courses may be identified based on course description, course prerequisites, course objectives, course location, term, enrollment process dates, enrollment steps, enrollment requirements, student information, first institution information, second institution information, credential requirements at the first and second institutions, and/or history of previous courses offered by the second institution and accepted as equivalent courses to courses offered by the first institution.

An implementation of the disclosed subject matter provides a system including a processor configured to receive course search criteria and provide a list of courses matching the course search criteria. Course details may be provided for each of the courses in the list of courses and the course details may include identification of an institution offering the course. A request to enroll for the course may be received and enrollment information may be provided to the institution. An indication may be received from the institution that enrollment for the course is complete.

An implementation of the disclosed subject matter provides a system including a processor configured to receive a user selection of a first course offered at a first institution and identify an equivalent course offered at a second institution that is accepted as an equivalent course at the first institution. As a result, the equivalent course may be presented to the user.

An implementation of the disclosed subject matter provides a system including a processor configured to receive a list of courses offered by a first institution and receive course information for each of the courses in the list. Equivalent courses may be identified for each of the courses in the list offered by a second institution and a map of course equivalencies may be generated based on the equivalent courses identified.

Additional features, advantages, and implementations of the disclosed subject matter may be set forth or apparent from consideration of the following detailed description, drawings, and claims. Moreover, it is to be understood that both the foregoing summary and the following detailed description are examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows a network configuration according to an implementation of the disclosed subject matter.

FIG. 2 shows an example process according to an implementation of the disclosed subject matter.

FIG. 3 shows an example process according to an implementation of the disclosed subject matter.

FIG. 4 shows an example data flow according to an implementation of the disclosed subject matter.

### DETAILED DESCRIPTION

Within the higher education model, it has become important for students to have the ability to view, select and access educational content from the broadest possible range of options via a single, unified interface. However, this capability does not currently exist. Institutions typically use locally installed, stand-alone enterprise resource planning (ERP) systems to manage course offerings and the student enrollment process. In this regard, each college or system is a siloed slice of the universe of available courses, requiring students to search course offerings one college or one institution or one provider at a time. This requires students to attempt to equate various courses despite different data structures and descriptive information from each institution.

The present disclosure provides systems and methods for (a) integrating course data across educational institutions, including credit and non-credit courses offered by institutions as well as educational content offered by third party course providers; (b) integrating enrollment processes across educational institutions; and (c) presenting course data and enrollment processes to a user via a single user interface.

An implementation of the disclosed subject matter includes acquiring course information from different institutions and educational content providers. This underlying data may be normalized and the resulting course data and enrollment requirements may be presented in a single user interface to a user. Additionally, enrollment data may be exchanged with individual institutions to effectuate enrollment of a user in a course.

Implementations described herein may include integrating course data and providing an interface to a user for accessing and viewing the consolidated data. A student enrolled in a credential program may determine alternate sources other than their primary institution for specific courses which may be required to complete their degree or certificate. Course and enrollment data may be presented to a user in a user interface. For example, the user interface may be in the form of a course marketplace, enabling a user to research courses and educational content across a spectrum of institutions. An institution may be a college, university, third-party educational provider, online course provider, high-school, technical school, vocational school, examination preparation provider, and similar educational providers.

As used herein, a user may be a prospective student, new student, current student, counselor, student advisor, or anyone interested in researching and/or enrolling in a course, institution, and credential program. A credential program may include a degree, diploma, certificate, and other earned certifications.

A user interface may enable a user to research courses and educational content from multiple institutions. According to an implementation of the present disclosure, a method for providing course options to a user is provided. The method includes receiving a user selection of a course offered at a first institution. Next, one or more equivalent courses offered at one or more other institutions that are accepted as an equivalent course at the first institution may be identified. Specifically, the step of identifying equivalent courses may be based on at least one attribute of an entity including: the user, first institution, alternate institutions, course offered at the first institution, and the equivalent courses offered at the alternate institutions. The identified equivalent courses may be presented to the user.

In an implementation, the user may be provided with a list of courses matching a course search criteria. The list of courses matching a course search criteria may be provided before or after receiving a user selection of a course offered at the first institution. For example, a user may wish to see all math courses at an alternate institution before selecting a specific course for which an equivalent course is desired. Alternatively, the user may select a specific course and search for equivalents of that course offered at an alternate institution. The method may further include receiving filtering criteria for filtering the list of courses and filtering the list of courses based on the filtering criteria.

Specifically, a database may include data elements for each institution based on a variety of course options such as courses offered and course type. The interface may allow the user to filter and view course options based on a variety of filtering criteria. For example, an attribute of a course or equivalent course may include subject matter, course schedule, course provider, course description, course prerequisites, course objectives, course location, term, format of the course (such as college campus-based, high-school campus based, online, hybrid, massive online open course (MOOC), and the like), dates and times of the course, course equivalencies and credential requirements at a specific institution satisfied by the course, cost of the course, course prerequisites, and other similar course factors. An attribute of an institution may include course credit awarded, enrollment process dates, enrollment steps and requirements, and any other data required for the enrollment process and/or to submit an application.

According to an implementation, a user may be able to prioritize course options and generate optimized series and lists of courses to enroll in based on a user's personal objectives. For example, an attribute of a user may include minimizing the total cost of a credential, devising a plan to earn a credential in view of schedule constraints, minimizing time to earn a credential, and other similar objectives.

According to an implementation, the method may further include receiving a request to enroll for one or more courses offered at one or more institutions, providing enrollment information to the other institution, and requesting enrollment information from a user based on enrollment requirements of the other institution. The method may also include receiving an indication from the other institution that enrollment for the relevant course is complete.

According to an implementation, the method may further include receiving a request to enroll for courses offered at multiple institutions, providing enrollment information to all desired institutions, and requesting enrollment information from a user based on enrollment requirements of all relevant institutions. The method may also include receiving an indication from each institution that enrollment for the relevant course is complete.

An implementation in accordance with the present disclosure may include allowing high school students to evaluate dual enrollment course options across multiple institutions regardless of whether the student's high school has an articulation agreement or partnership with the institution. This may include online courses regardless of the physical location of the institution offering the course.

According to an implementation, data on continuing education courses offered by institutions to adult learners may be integrated such that a prospective student is able to view available course offerings from multiple institutions. In this case, the user interface may collect information needed for enrollment in a non-credit course. The data may be integrated with the institution's ERP system. This data integration may occur in a manner that preserves the ERP system as the system of record for all student enrollment and registration despite the differences in the enrollment processes between for-credit institution courses and non-credit continuing education courses.

Additionally, the database may include a comprehensive history of all previous transactions with which the system may be able to generate queries, reports, and correlate data on transactions with third party data and any other similar data describing a course.

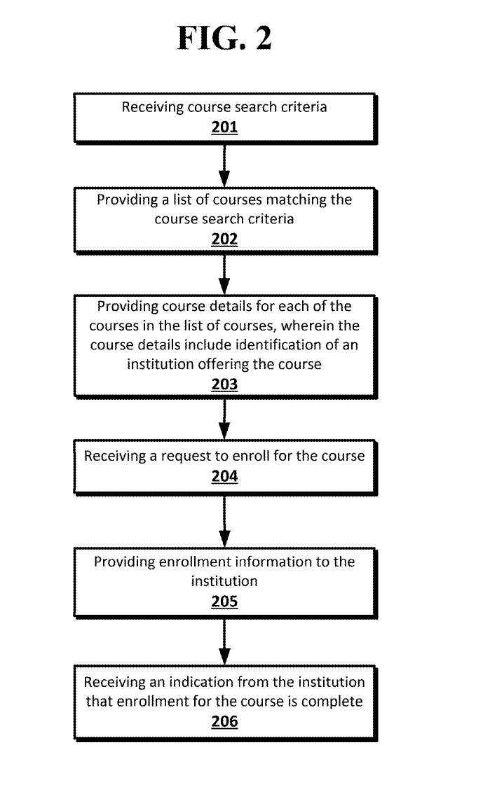

An implementation in accordance with the present disclosure may include a method for receiving enrollment for a course, as shown in FIG. 2. The method may include receiving course search criteria at 201, providing a list of courses matching the course search criteria at 202, and providing course details for each of the courses in the list of courses at 203. Specifically, the course details may include identification of an institution offering the course. Next, the method may include receiving a request to enroll for the course at 204, providing enrollment information to the institution at 205, and receiving an indication from the institution that enrollment for the course is complete at 206.

According to an implementation, the method may include receiving filtering criteria for filtering the list of courses and filtering the list of courses based on the filtering criteria. The filtering criteria may subject matter, course schedule, course provider, course description, course prerequisites, course objectives, course location, term, format of the course (such as college campus-based, high-school campus based, online, hybrid, massive online open course MOOC, and the like), dates and times of the course, course equivalencies and credential requirements at a specific institution satisfied by the course, cost of the course, course prerequisites, and other similar course and/or institution factors.

In an implementation, the method may include requesting enrollment information from a user based on an enrollment requirement of the institution offering a course. The method may include requesting the enrollment information from a user who has requested to enroll in the course.

For example, enrollment information may include user name, user address, user payment information, user billing information, user personal identification information, user eligibility information, user's previous credit hours earned, user GPA, and other information necessary for enrollment.

In an implementation, the method may include requesting enrollment information from third parties based on an enrollment requirement of the institution offering a course. The method may include requesting consent to obtain the enrollment information from a user who has requested to enroll in the course.

For example, enrollment information may include user GPA, user educational/course transcripts, user test scores, parental permission for users under the age of 18, consent from other educational institution attended by user if required, and other information necessary for enrollment.

Further, an enrollment system for completing an enrollment process is provided. The enrollment system may integrate with an institutional admission system such that the institutional admission system completes some portion of the enrollment process. The enrollment system may be notified when such outsourced process elements have been completed by the institutional admission system.

In an implementation, an enrollment system may facilitate the enrollment process based on trans-institutional course selection. The enrollment process may include processes for comparing student-provided enrollment information with specific institutional enrollment requirements. The enrollment process may be customized to the student and institution by modifying steps and requirements presented to the student based on the comparison of student-provided enrollment information with specific institutional enrollment requirements.

The enrollment system may provide an exchange of data with institutional ERP systems. The ERP system may determine the appropriate fees and collect payment for enrollment in a course. Next, the system and the ERP system may exchange payment status regarding enrollment for a course. Examples of ERP systems for exchange of data with an enrollment system are Ellucian Colleague, Ellucian Banner, Peoplesoft SIS, Jenzabar, and the like. Further, the system may secure a location for intermediary posting of data files pursuant to the data exchange with the ERP system. Additionally, the enrollment system may allow institutional personnel to review and approve enrollment data prior to exchange of data with the ERP system.

The enrollment system may correlate student enrollment information, institutional fee structure, ancilliary products/services offered in conjunction with courses, such as books, parking, childcare, and the like, to determine the cost of a course and any selected additional items. The system may collect payment, remit payment to the institution, and exchange data with the ERP system or other institutional system with regard to fees and payment. In an implementation, and institutional ERP system may determine appropriate fees and collect payment, and exchange payment status with the enrollment system.

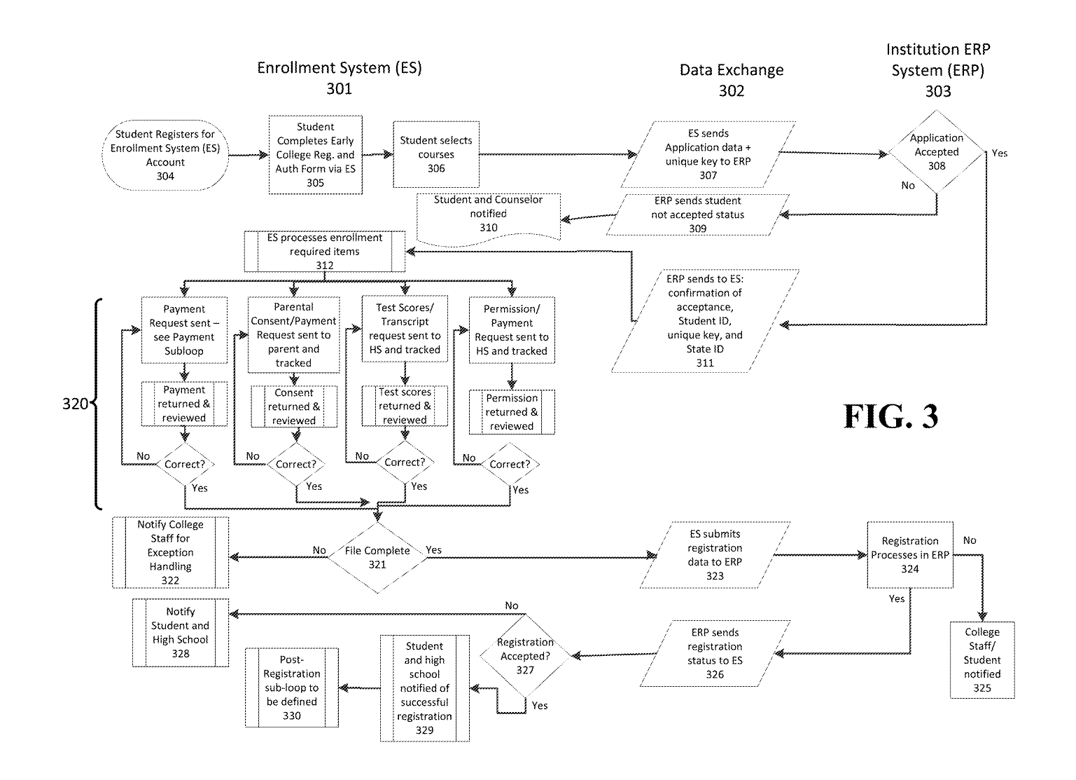

FIG. 3 shows a specific example process according to an implementation of the disclosed subject matter. As shown, an enrollment system may allow a user to register for an enrollment system (ES) 301 account, at 304, and complete various forms such as a college registration and authorization forms, at 305. A user may select a course, at 306, and the course selection and application data may be sent, for example via a data exchange 302, to an institution

ERP system (ERP) 303. In some cases, the data exchange 302 may generate a unique key associated with the specific application and may provide the unique key to the ERP system along with the application data, at 307. The ERP system 303 may determine if the application is accepted at 308, and if the application is accepted, the ERP system 303 may send confirmation of acceptance, student identification information, unique key, and state identification information to the ES 301, at 311. If the ERP system 303 determines that the application is not accepted, the ERP system 303 may send a status indicating that the application was not accepted to the student and/or counselor, at 309, and as a result, the student and/or counselor may be notified that the application was not accepted at 310. If the ERP system 303 determines that the application is accepted, the ES 301 may process enrollment required items at 312. As shown at 320, the ES 301 may receive and process enrollment data such as payment, parental consent, test scores and transcripts, permission, and any other data necessary for the enrollment process as shown. The ES 301 may determine, for each enrollment required item, whether the enrollment data received is sufficient to satisfy the particular enrollment required item. Where any required enrollment items are missing or incorrect, the ES 301 may request those items from the user or take any other action to correct or identify the incorrect items, as shown by the various decision points. At 321, the ES 301 may determine whether enrollment is complete. If enrollment is incomplete, the ES 301 may notify college staff for handling of the incomplete application at 322. In enrollment is complete, the ES 301 may send this enrollment data to the ERP 303 at 323, and the ERP 303 may process registration for the course at 324. The ERP 303 may send a registration status to the ES 301 at 326, and the ES 301 may notify the user and others if registration for the course has been accepted or not at 327. As a result of successful registration, the ES 301 may notify the student and/or high school of successful registration at 329. Following the successful registration notification at 329, the system may proceed with any post-registration processing, as necessary, at 330. In some cases, if the ERP 303 is unable to process registration at 324, college staff and/or the student may be notified at 325.

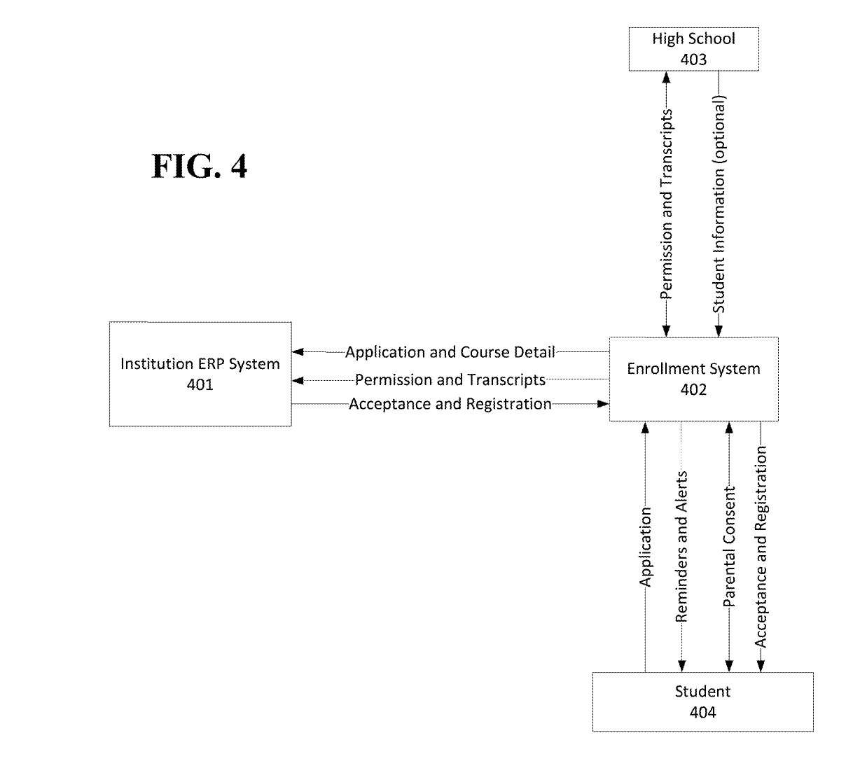

FIG. 4 shows a specific example data flow according to an implementation of the disclosed subject matter, such as for a high school student who is searching and registering for an educational course at another institution. For example, the student 404 may be registering for one or more courses that provide college credit in addition to credit at the student's high school. As shown, an enrollment system (ES) 402 may communicate with a high school 403, a student 404, and an institution ERP system (ERP) 401. Any information may be exchanged between the ES 402, ERP 401, student 404, and high school 403, as necessary to identify and register for a course. Data relating to permission and transcripts may be exchanged between the ES 402 and the high school 403. Optionally, the high school 403 may provide student information to the ES 402, such as information that is required for registration. As shown, the ES 402 may provide data to the ERP system 401. For example, the ES 402 may provide an application, course details, permission, and transcripts, to the ERP system 401. The ERP system 401 may provide acceptance and registration details to the ES 402. Additionally, data may be exchanged between a student 404 and the ES 402. As shown, a student 404 may provide data for an application to the ES 402. The ES 402 may send data to the student 404 such as reminders, alerts, and acceptance and registration details. Further, the student 404 and the ES 402 may exchange data regarding parental consent. Data flows such as those shown in FIG. 4 may be used, for example, to implement the processes disclosed elsewhere herein.

An implementation according to the present disclosure includes a method for generating a map of course equivalencies. The method may include receiving a list of courses offered by a first institution and receiving course information for each of the courses in the list. Next, equivalent courses for each of the courses in the list offered by a second institution may be identified. As a result, a map of course equivalencies based on the equivalent courses identified may be generated.

In particular, the equivalent courses may be identified based on at least one factor including: course description, course prerequisites, course objectives, course location, term, enrollment process dates, enrollment steps, enrollment requirements, student information, first institution information, second institution information, credential requirements at the first and second institutions, history of previous courses offered by the second institution and accepted as equivalent courses to courses offered by the first institution.

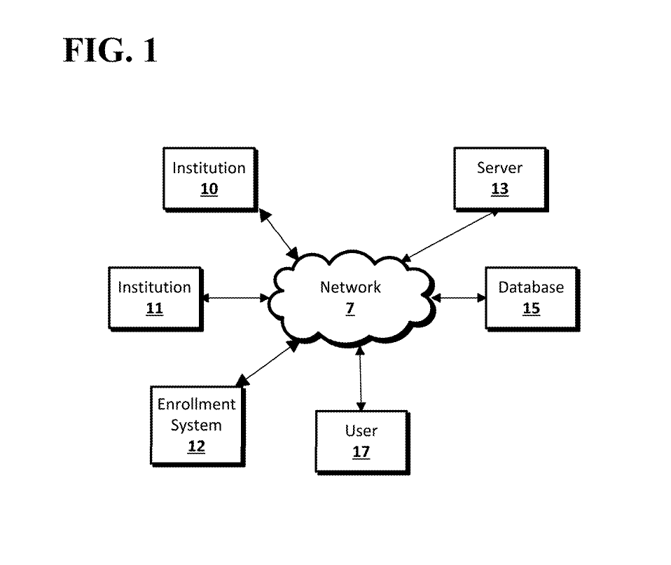

Implementations of the presently disclosed subject matter may be implemented in and used with a variety of component and network architectures. FIG. 1 shows an example network arrangement according to an implementation of the disclosed subject matter. One or more institutions 10, 11, which may include ERP systems, and the like may connect to other devices via one or more networks 7. The network may be a local network, wide-area network, the Internet, or any other suitable communication network or networks, and may be implemented on any suitable platform including wired and/or wireless networks. The institutions 10, 11 may communicate with one or more enrollment systems 12, user platforms 17, servers 13 and/or databases 15. The institutions 10, 11, and enrollment systems 12 may be directly accessible by the user platform 17, or one or more other devices may provide intermediary access such as where a server 13 provides access to resources stored in a database 15. The institutions 10, 11 and enrollment systems 12 also may access user platforms 17 or services provided by user platforms 17 such as cloud computing arrangements and services. The enrollment systems 12 may include one or more servers 13 and/or databases 15.

More generally, various implementations of the presently disclosed subject matter may include or be embodied in the form of computer-implemented processes and apparatuses for practicing those processes. Implementations also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that embodies all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method for receiving enrollment for a course comprising:
receiving course search criteria,
providing a list of courses matching the course search criteria,
providing course details for each of the courses in the list of courses, wherein the course details include identification of an institution offering the course,
receiving a request to enroll for a first course in the list of courses,
providing enrollment information to the institution offering the first course,
receiving an indication from the institution that enrollment for the first course is complete.

2. The method of claim 1, further comprising:
receiving filtering criteria for filtering the list of courses,
filtering the list of courses based on the filtering criteria.

3. The method of claim 2, wherein the filtering criteria is at least one selected from the group consisting of: physical location of a course, format of a course, date/time of a course, course equivalencies, credential requirements at a specific institution satisfied by a course, cost of a course, and a course prerequisite.

4. The method of claim 1, wherein the list of courses includes courses from multiple educational institutions.

5. The method of claim 1, further comprising requesting the enrollment information from a user based on an enrollment requirement of the institution offering the first course.

6. The method of claim 1, further comprising requesting the enrollment information from a user who has requested to enroll in the first course.

7. The method of claim 1, wherein the enrollment information is at least one selected from the group consisting of: user name, user address, user payment information, user billing information, user personal identification information, user eligibility information, user's previous credit hours earned, user GPA, and other information necessary for enrollment.

8. The method of claim 1, further comprising requesting the enrollment information from a third-party based on an enrollment requirement of the institution offering the first course.

9. A method for providing course options to a user, comprising:
receiving a user selection of a first course offered at a first institution,
identifying an equivalent course offered at a second institution that is accepted as an equivalent course at the first institution,
presenting the equivalent course to the user.

10. The method of claim 9, wherein identifying an equivalent course is based on at least one attribute of an entity selected from the group consisting of: the user, first institution, second institution, course offered at the first institution, and the equivalent course offered at the second institution.

11. The method of claim 9, further comprising:
receiving a request to enroll for the equivalent course offered at the second institution,
providing enrollment information to the second institution,
receiving an indication from the second institution that enrollment for the equivalent course is complete.

12. The method of claim 9, further comprising:
prior to receiving the user selection of a course offered at the first institution, providing the user with a list of courses matching a course search criteria, wherein the list includes the first course.

13. The method of claim 12, further comprising:
receiving filtering criteria for filtering the list of courses,
filtering the list of courses based on the filtering criteria.

14. The method of claim 11, further comprising requesting enrollment information from a user based on an enrollment requirement of the second institution.

15. A method for generating a map of course equivalencies, comprising:
receiving a list of courses offered by a first institution,
receiving course information for each of the courses in the list,
identifying equivalent courses for each of the courses in the list offered by a second institution,
generating a map of course equivalencies based on the equivalent courses identified.

16. The method of claim 15, wherein the equivalent courses are identified based on at least one factor selected from the group consisting of: course description, course prerequisites, course objectives, course location, term, enrollment process dates, enrollment steps, enrollment requirements, student information, first institution information, second institution information, credential requirements at the first and second institutions, history of previous courses offered by the second institution and accepted as equivalent courses to courses offered by the first institution.
